(19) United States
(12) Patent Application Publication
(10) Pub. No.: US 2026/0353370 A1
(43) Pub. Date: Nov. 5, 2026

(54) METHODS, ARCHITECTURES, APPARATUSES, AND SYSTEMS FOR ALLOCATING RESOURCES FOR AMBIENT INTERNET OF THINGS DEVICES

(71) Applicant: InterDigital Patent Holdings, Inc., Wilmington, DE (US)

(72) Inventors: Kevin Wanuga, Souderton, PA (US); Erdem Bala, East Meadow, NY (US); Martino Freda, Laval (CA); Jongwoo Hong, New York, NY (US); Paul Marinier, Brossard (CA)

(21) Appl. No.: 19/199,070

(22) Filed: May 5, 2025

(51) Int. Cl. H04W 72/0446; H04W 68/02; H04W 72/0453; H04W 74/0833

(52) U.S. Cl. CPC H04W 72/0446; H04W 68/02; H04W 72/0453; H04W 74/0833

(57) ABSTRACT

Procedures, methods, architectures, apparatuses, systems, devices, and computer program products are provided for communication with ambient internet of things (A-IoT) devices. Wireless transmit/receive unit (WTRU) methods and systems include receiving, from a wireless network, configuration information indicating a resource allocation for a plurality of A-IoT devices and transmitting, to the plurality of A-IoT devices, a paging message indicating resource parameters determined based on the resource allocation. The WTRU methods and systems further include receiving a transmission from an A-IoT device of the plurality of A-IoT devices, where the transmission from the A-IoT device uses resources identified by the resource parameters. The WTRU methods and systems additionally include causing an operation to be performed based on the received transmission.

### TECHNICAL FIELD

The present disclosure is generally directed to the fields of communications, software, and encoding/decoding, including, for example, to methods, architectures, apparatuses, systems related to communication with ambient internet of things (A-IoT) devices.

### BACKGROUND

Devices (e.g., wireless transmit/receive units) that are communicatively coupled to a wireless network may be configured by the wireless network to identify a plurality of A-IoT devices by receiving transmissions from the plurality of A-IoT devices (e.g., as part of a random access procedure). During this process, collisions between received transmissions may occur.

### SUMMARY

A wireless transmit/receive unit (WTRU) may be configured for identification of A-IoT devices. For example, as part of an A-IoT random access procedure, a WTRU may transmit an indication to a plurality of A-IoT devices to transmit a message to the WTRU (e.g., comprising an A-IoT device ID). However, the messages transmitted by the plurality of A-IoT devices in response to the indication may result in one or more collisions at the WTRU. Accordingly, systems and methods are desired for a WTRU to determine and communicate resource allocations for A-IoT transmissions to avoid such collisions. In accordance with certain embodiments of this disclosure, the WTRU determines resource parameters based on a resource allocation received from a wireless network and transmits a paging message indicating the resource parameters to the plurality of A-IoT devices. The WTRU may receive transmissions from the plurality of A-IoT devices that use resources identified by the resource parameters, and cause operations to be performed based on such transmissions. Based on the systems and methods of this disclosure, collisions during A-IoT random access procedures may be avoided and resource parameters of A-IoT random access procedures may be optimized to increase spectral efficiency and decrease transmission monitoring windows of A-IoT devices.

In accordance with certain embodiments of the present disclosure, methods and systems are provided for operating a WTRU. A method includes receiving, from a wireless network, configuration information indicating a resource allocation for a plurality of A-IoT devices. The method further includes determining resource parameters based on the resource allocation, where the resource parameters include at least one of a time domain resource or a frequency domain resource. The method additionally includes transmitting, to the plurality of A-IoT devices, a paging message indicating the resource parameters. The method also includes receiving a transmission from an A-IoT device of the plurality of A-IoT devices, where the transmission from the A-IoT device uses resources identified by the resource parameters. The method further includes causing an operation to be performed based on the received transmission.

In some embodiments, the resource parameters include the time domain resource and the paging message indicates a time offset corresponding to the time domain resource. In some embodiments, the time offset is based on at least one of: a minimum processing time associated with the plurality of A-IoT devices or a maximum time offset associated with the plurality of A-IoT devices. In some embodiments, the resource parameters include a first time domain resource and a second time domain resource, and the paging message indicates a first time offset corresponding to the first time domain resource and a second time offset corresponding to the second time domain resource. In some embodiments, the first time offset is based on at least one of: a minimum processing time associated with the plurality of A-IoT devices; a sampling frequency offset between the WTRU and the plurality of A-IoT devices; a maximum time offset associated with the plurality of A-IoT devices; a maximum propagation latency associated with the plurality of A-IoT devices; or a transmission duration associated with the plurality of A-IoT devices. In some embodiments, the second time offset is based on at least one of: a maximum monitoring window associated with the plurality of A-IoT devices; a receive/transmit switching time associated with the WTRU; the maximum propagation latency associated with the plurality of A-IoT devices; the sampling frequency offset between the WTRU and the plurality of A-IoT devices; or the transmission duration associated with the plurality of A-IoT devices. In some embodiments, the paging message indicates a range of time offset values corresponding to the time domain resource.

In some embodiments, transmitting the paging message is a part of a random access procedure for the plurality of A-IoT devices. In some embodiments, causing the operation to be performed includes performing at least one of the following steps in relation to a re-access procedure: determining, based on the received transmission, that the resource allocation is not sufficient to complete the random access procedure for the plurality of A-IoT devices; transmitting, to the wireless network, a request to update the resource allocation; receiving, from the wireless network, updated configuration information indicating an updated resource allocation for the plurality of A-IoT devices; determining updated resource parameters based on the updated resource allocation; transmitting, to the plurality of A-IoT devices, a re-access paging message indicating the updated resource parameters; combinations of the same; or the like. In some embodiments, causing the operation to be performed includes determining, based on the received transmission, that the random access procedure was completed successfully for the plurality of A-IoT devices, and transmitting, to the wireless network, an indication to de-activate the resource allocation.

In some embodiments, causing the operation to be performed includes performing at least one of the following steps in relation to resource parameter adjustment: determining, based on the received transmission, to adjust the resource parameters; adjusting, based on the resource allocation, the resource parameters; or transmitting, to the plurality of A-IoT devices, an indication of the adjusted resource parameters; combinations of the same; or the like. In some embodiments, determining to adjust the resource parameters is based on at least one of: identifying one or more collisions associated with the resources used to transmit the received transmission, or identifying a failure to recover the received transmission.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram depicting an example topology for A-IoT signaling involving bidirectional communication between an A-IoT device and a base station, in accordance with certain embodiments;

FIG. 3 is a diagram depicting an example topology for A-IoT signaling involving bidirectional communication between an A-IoT device and an intermediate node, in accordance with certain embodiments;

FIG. 4 is a diagram depicting an example topology for A-IoT signaling involving downlink assistance from an assisting node, in accordance with certain embodiments;

FIG. 5 is a diagram depicting an example topology for A-IoT signaling involving uplink assistance from an assisting node, in accordance with certain embodiments;

FIG. 6 is a diagram depicting an example topology for A-IoT signaling involving bidirectional communication between an A-IoT device and a WTRU, in accordance with certain embodiments;

FIG. 7 is a flowchart depicting an example random access procedure for identification of A-IoT devices, in accordance with certain embodiments;

FIG. 8 is a diagram depicting example timing relationships for transmissions of a random access procedure, in accordance with certain embodiments;

FIG. 9A is a diagram depicting an example collision between resources for transmissions of a random access procedure, in accordance with certain embodiments;

FIG. 9B is a diagram depicting example timing relationships for avoiding collisions between resources for transmissions of a random access procedure, in accordance with certain embodiments;

FIG. 10 is a diagram depicting example time domain offset indications varying across different frequency resources, in accordance with certain embodiments;

FIG. 11 is a diagram depicting an example of updating resource parameters during a random access procedure, in accordance with certain embodiments;

FIG. 12 is a flowchart of an illustrative method for reallocating resources for a random access procedure, in accordance with certain embodiments; and

FIG. 13 is a flowchart of an illustrative method performed by a WTRU for allocating time domain resources for A-IoT devices.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

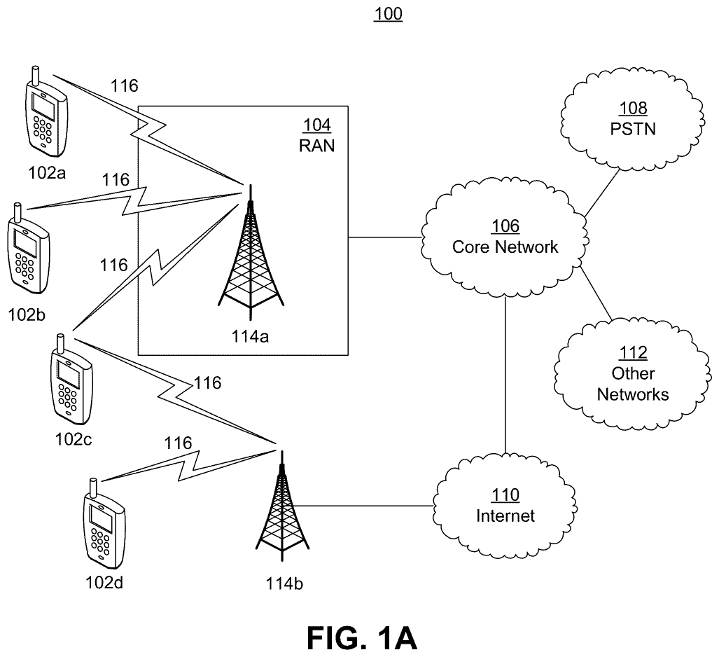

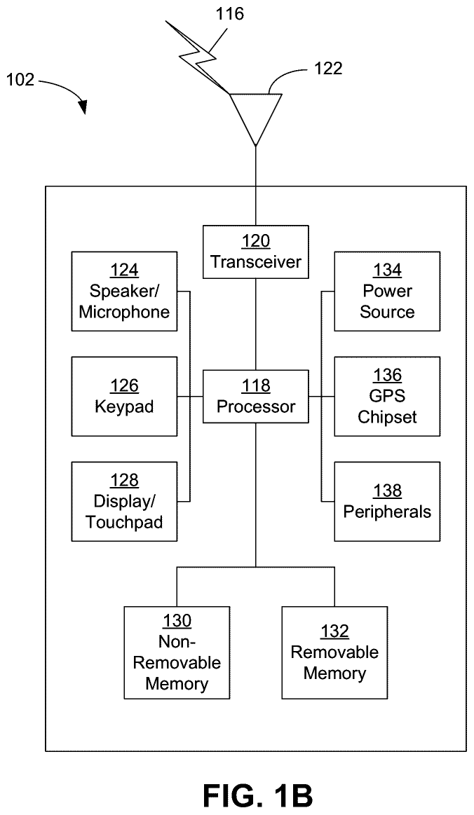

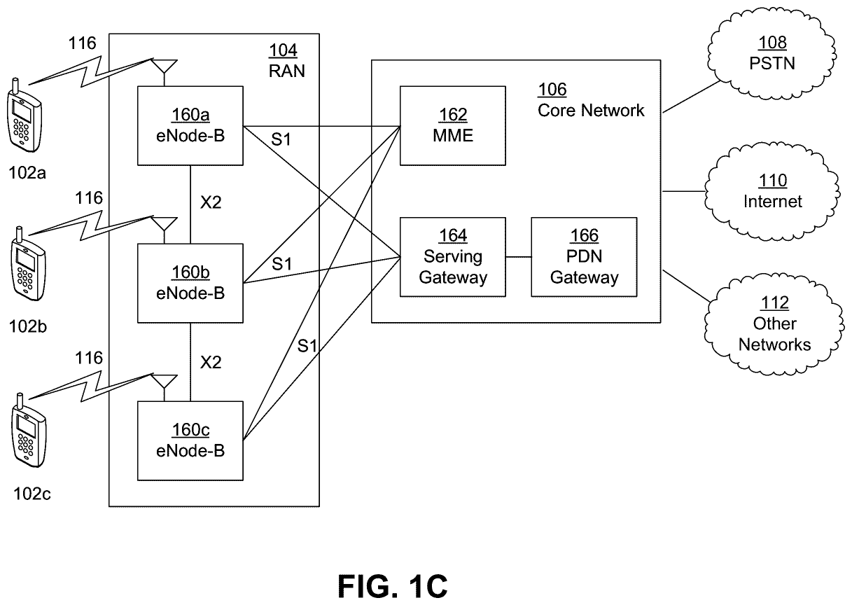

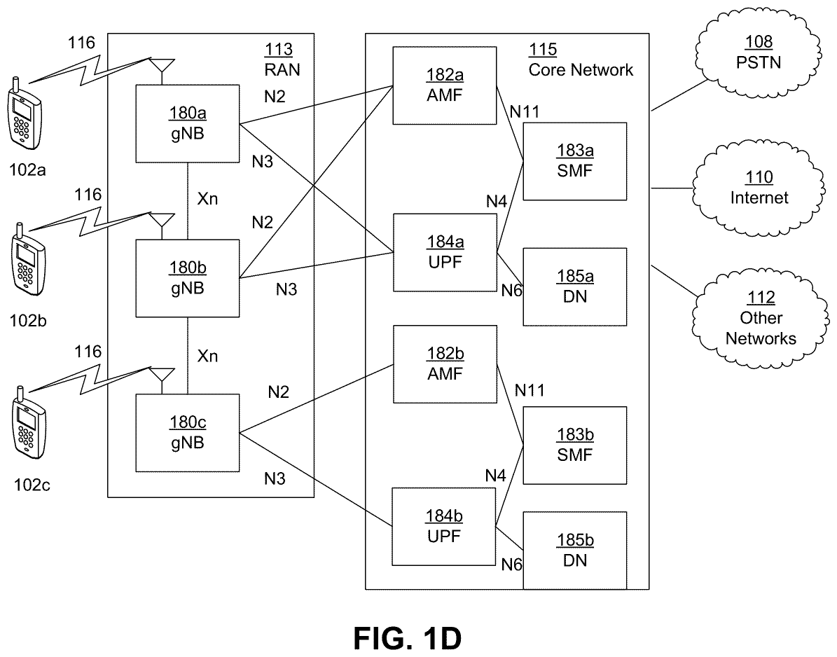

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNB, a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any network functions, one or more RANs, one or more application functions, one or more access and mobility management functions (AMFs), any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

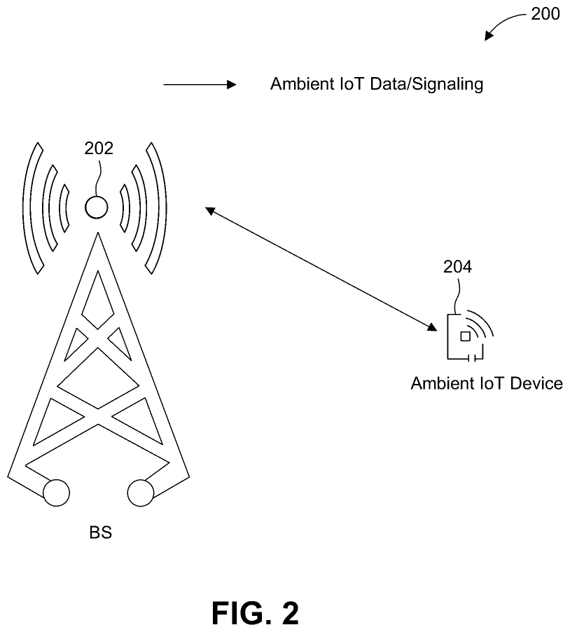

In certain embodiments of the present disclosure, including those described below at least in connection with FIGS. 2-13, the devices, systems, architectures, communication links, apparatuses, and other elements depicted in FIGS. 1A-1D may be used in connection with resource allocation for A-IoT devices.

As internet of things (IoT) devices rise in popularity, an increasing number of everyday objects are expected to be interconnected, improving productivity, efficiency, and user comfort. Further reductions in the size, complexity, and/or power consumption of IoT devices may enable the deployment of up to hundreds of billions of IoT devices for various applications, adding value across the entire value chain. However, powering each and every IoT device by a battery that requires manual recharging or replacement may result in high maintenance costs and harm the environment. In some use cases, IoT devices requiring such batteries may even become safety hazards (e.g., a wireless sensor in the electric power and petroleum industry).

Accordingly, battery-less IoT devices or IoT devices with limited energy storage (e.g., not requiring manual replacement or recharging of the energy storage) are desired. Such ambient internet of things (A-IoT) devices are typically limited in size and complexity. In some approaches, an energy harvester is used to power A-IoT devices. However, since the output power of an energy harvester typically ranges from 1 microwatt (μW) to a few hundred μWs, cellular devices with a peak power consumption greater than 10 milliwatts (mW) may not be suitable for being powered by energy harvesting.

In accordance with certain embodiments of the present disclosure, A-IoT data transmission and signaling topologies are described as follows.

FIG. 2 is a diagram depicting an example topology 200 for A-IoT signaling involving bidirectional communication between an A-IoT device 204 and a base station 202, in accordance with certain embodiments.

As shown in FIG. 2, in some approaches, the A-IoT device 204 directly communicates bidirectionally with a base station 202 (e.g., base stations 114a, 114b of FIG. 1A, eNode-Bs 160a-c of FIG. 1B, gNBs 180a-c of FIG. 1D) of a wireless network (e.g., RAN 104 and 113 of FIGS. 1A-D and/or core network 106 and 115 of FIGS. 1A-D). For example, the communication between the A-IoT device 204 and the base station 202 may include A-IoT data and/or signaling. Further, for example, the base station 202 transmitting (e.g., the A-IoT data) to the A-IoT device 204 may be a different base station from the base station 202 receiving (e.g., the A-IoT data) from the A-IoT device 204.

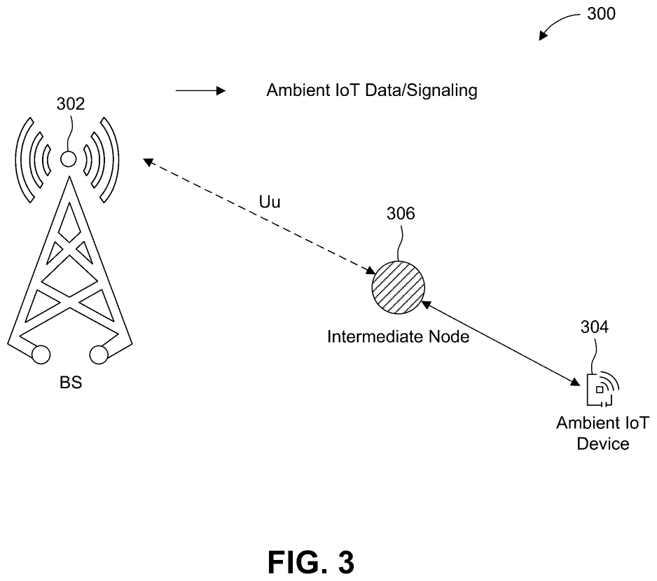

FIG. 3 is a diagram depicting an example topology 300 for A-IoT signaling involving bidirectional communication between an A-IoT device 304 and an intermediate node 306, in accordance with certain embodiments.

As shown in FIG. 3, in some approaches, the A-IoT device 304 communicates bidirectionally with an intermediate node 306 between the A-IoT device 304 and a base station 302 (e.g., base stations 114a, 114b of FIG. 1A, eNode-Bs 160a-c of FIG. 1B, gNBs 180a-c of FIG. 1D) of a wireless network (e.g., RAN 104 and 113 of FIGS. 1A-D and/or core network 106 and 115 of FIGS. 1A-D). For example, the intermediate node 306 may comprise or correspond to at least one of: a WTRU (e.g., WTRU 102a-d of FIGS. 1A-1D); a relay; an integrated access and backhaul (IAB) node; a repeater; or the like. Further, for example, the intermediate node may be capable of A-IoT signaling and may transfer A-IoT information between the base station 302 and the A-IoT device 304.

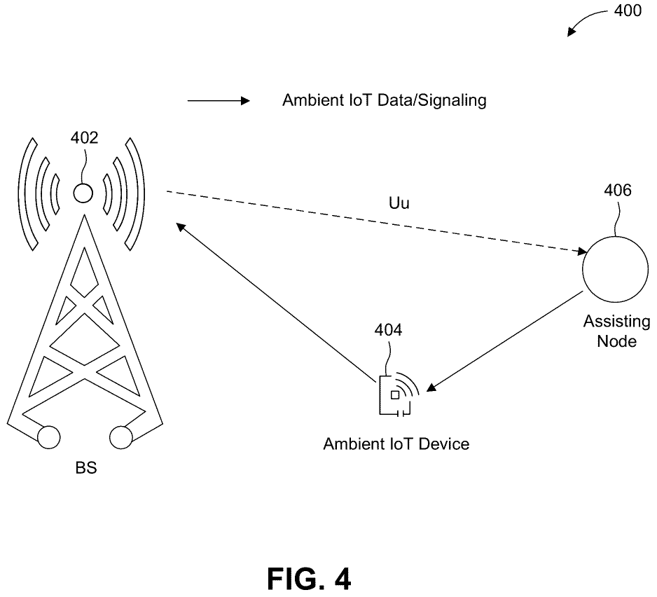

FIG. 4 is a diagram depicting an example topology 400 for A-IoT signaling involving downlink assistance from an assisting node 406, in accordance with certain embodiments.

As shown in FIG. 4, in some approaches, the A-IoT device 404 transmits A-IoT data and/or signaling to a base station 402 (e.g., base stations 114a, 114b of FIG. 1A, eNode-Bs 160a-c of FIG. 1B, gNBs 180a-c of FIG. 1D) of a wireless network (e.g., RAN 104 and 113 of FIGS. 1A-D and/or core network 106 and 115 of FIGS. 1A-D). For example, the assisting node 406 may correspond to at least one of: a WTRU (e.g., WTRU 102a-d of FIGS. 1A-1D); a relay; an integrated access and backhaul (IAB) node; a repeater; or the like. Further, for example, the assisting node 406 may be capable of A-IoT signaling and may, based on the one or more transmissions received from the base station 402, transmit A-IoT data and/or signaling to the A-IoT device 404.

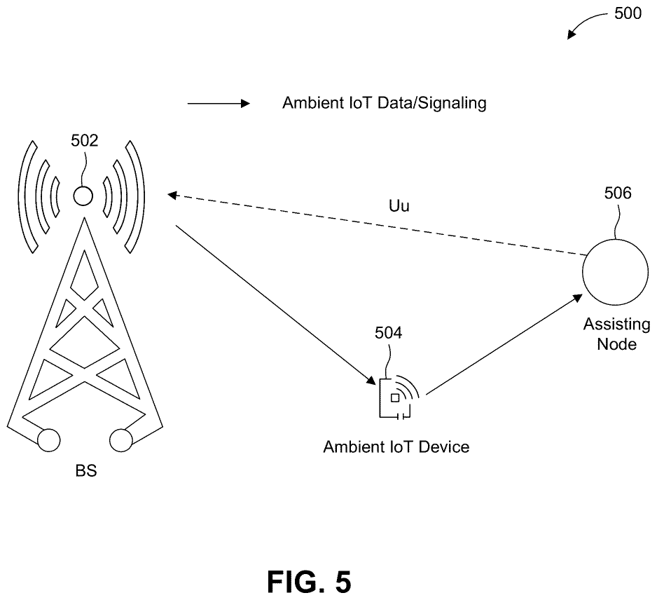

FIG. 5 is a diagram depicting an example topology 500 for A-IoT signaling involving uplink assistance from an assisting node 506, in accordance with certain embodiments.

As shown in FIG. 5, in some approaches, the A-IoT device 504 receives A-IoT data and/or signaling from a base station 502 (e.g., base stations 114a, 114b of FIG. 1A, eNode-Bs 160a-c of FIG. 1B, gNBs 180a-c of FIG. 1D) of a wireless network (e.g., RAN 104 and 113 of FIGS. 1A-D and/or core network 106 and 115 of FIGS. 1A-D). For example, the assisting node 506 may comprise or correspond to at least one of: a WTRU (e.g., WTRU 102a-d of FIGS. 1A-1D); a relay; an integrated access and backhaul (IAB) node; a repeater; or the like. Also, for example, the A-IoT device 504 may transmit A-IoT data and/or signaling to the assisting node 506. Further, for example, the assisting node 506 may be capable of A-IoT signaling and may, based on the A-IoT data and/or signaling received from the A-IoT device 504, transmit information to the base station 502.

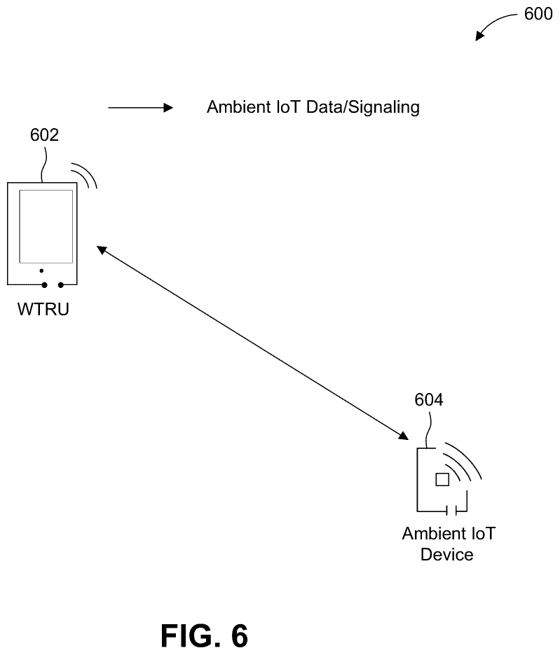

FIG. 6 is a diagram depicting an example topology 600 for A-IoT signaling involving bidirectional communication between an A-IoT device 604 and a WTRU 602, in accordance with certain embodiments.

As shown in FIG. 6, in some approaches, the A-IoT device 604 communicates bidirectionally with a WTRU 602. For example, the communication between the A-IoT device 406 and the WTRU 602 may include A-IoT data and/or signaling.

In accordance with certain embodiments of the present disclosure, a random access framework for A-IoT devices is described as follows.

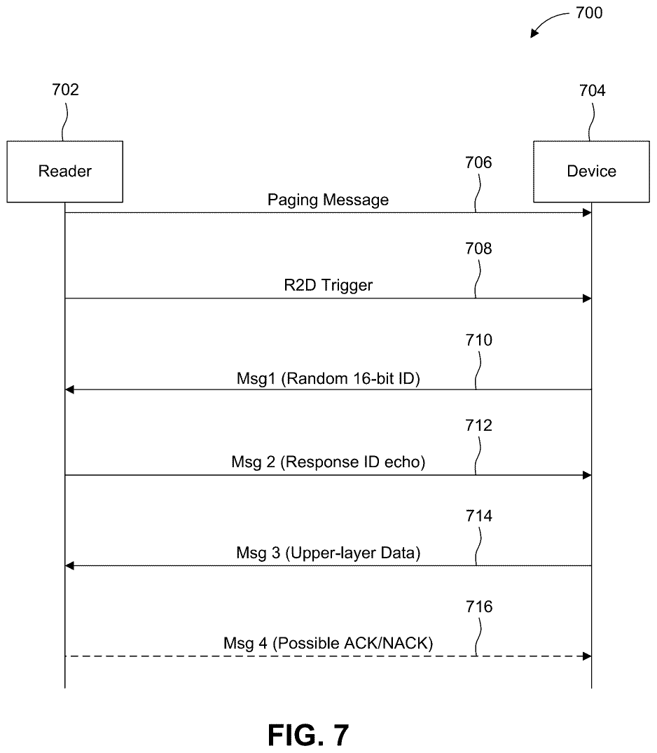

FIG. 7 is a flowchart 700 depicting an example random access procedure for identification of A-IoT devices, in accordance with certain embodiments.

For example, as shown in FIG. 7, a reader 702 (e.g., base stations 202, 302, 402, and 502 of FIGS. 2-5, intermediate node 306 of FIG. 3, assisting node 406 of FIG. 4, WTRU 602 of FIG. 6) may perform at least one of the following steps: transmitting a paging message 706 to an A-IoT device 704; transmitting a reader-to-device (R2D) trigger 708 to the A-IoT device 704; receiving a first message (msg1) 710 from the A-IoT device 704; transmitting a second message (msg2) 712 to the A-IoT device 704; receiving a third message (msg3) 714 from the A-IoT device 704; transmitting a fourth message (msg4) 716 to the A-IoT device 704; combinations of the same; or the like. Further, for example, an A-IoT device 704 (e.g., A-IoT devices 204, 304, 404, 504, and 604 of FIGS. 2-6) may perform at least one of the following steps: receiving a paging message 706 from a reader device 702; receiving a reader-to-device (R2D) trigger 708 from the reader device 702; transmitting a first message (msg1) 710 to the reader device 702; receiving a second message (msg2) 712 from the reader device 702; receiving a third message (msg3) 714 to the reader device 702; receiving a fourth message (msg4) 716 from the reader device 702; combinations of the same; or the like.

For example, the paging message 706 may indicate relevant parameters to be used by the A-IoT device 704 for the transmission of msg1. Further, for example, the relevant parameters may include time domain resource allocations, frequency domain resource allocations, access control information, or the like. Moreover, for example, the paging message 706 may indicate msg1 occasions and the R2D trigger 708 may delimit the indicated msg1 occasions. Additionally, for example, the A-IoT device 704 may select a msg1 occasion of the indicated msg1 occasions for use in transmission of a random device ID (e.g., 16-bit ID) in msg1. Also, for example, the reader 702, upon receiving msg1 710, transmits msg2 712. In some examples, the reader 702 includes the random device ID of msg1 710 in msg2 712. Even further, for example, the device 704 receives the echoed random device ID in msg2 712 and transmits msg3 714. In some examples, msg3 714 includes upper layer data (e.g., an application layer device ID). Also, for example, the reader 702 may transmit msg4 716 (e.g., for subsequent command transmission). In some examples, the contention is resolved upon successful receipt of msg2 712.

In accordance with certain embodiments of the present disclosure, multiplexing of msg1 710 occasions is described as follows.

In some approaches, frequency division multiple access (FDMA) is used to enable multiple device-to-reader (D2R) msg1 transmissions in response to a R2D transmission triggering random access (e.g., R2D trigger 708).

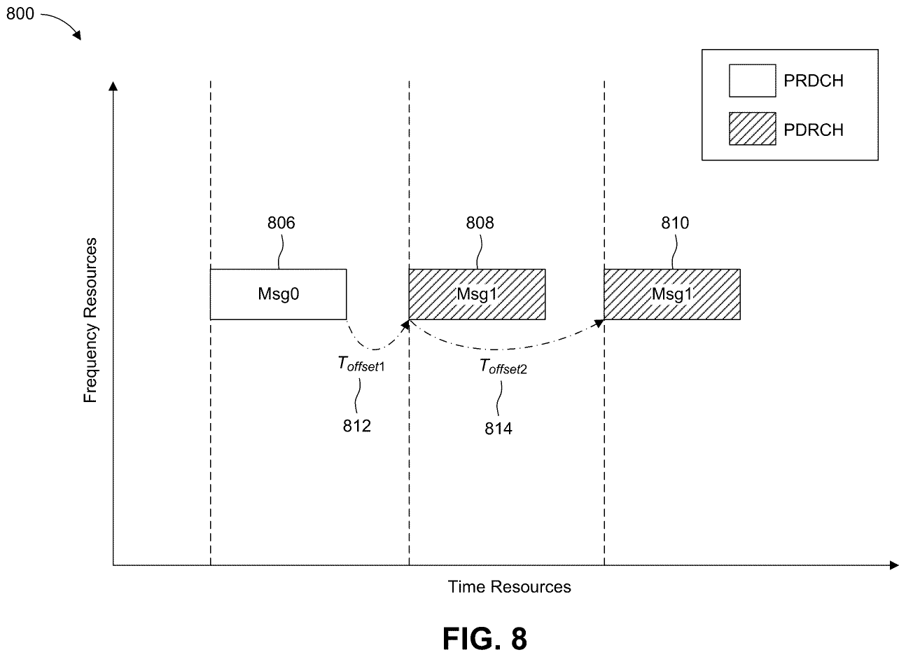

FIG. 8 is a diagram 800 depicting example timing relationships for transmissions of a random access procedure, in accordance with certain embodiments.

As shown in FIG. 8, in some approaches, time division multiple access (TDMA) is used to indicate a plurality of time domain resources for D2R msg1 transmissions in response to a R2D transmission triggering random access (e.g., msg0 806). For example, each D2R msg1 transmission occurs in one time domain resource of the indicated plurality of time domain resources. Further, for example, only a single time domain resource may be indicated for D2R msg3 transmissions in response to a physical reader to device channel (PRDCH) for msg2 transmissions. Also, for example, a first time domain resource 808 (e.g., for msg1) of the plurality of time domain resources may have a first time offset 812 following the end of the corresponding R2D transmission triggering random access (e.g., msg0 806). Additionally, for example, a second time domain resource 810 (e.g., for msg1) of the plurality of time domain resources may have a second time offset 814 following the start time of the msg1 time domain resource. In some embodiments, the first time offset and/or the second time offset are indicated implicitly or explicitly by the R2D transmission triggering random access (e.g., msg0 806). In some embodiments, the first time offset and/or the second time offset are predefined values. In some embodiments, the second time offset is derived from a rule.

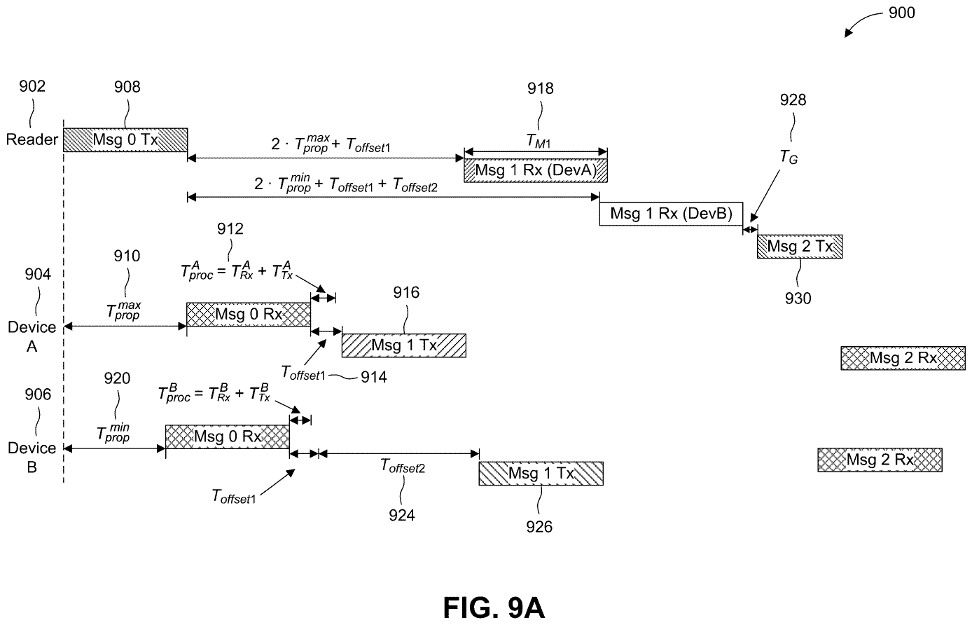

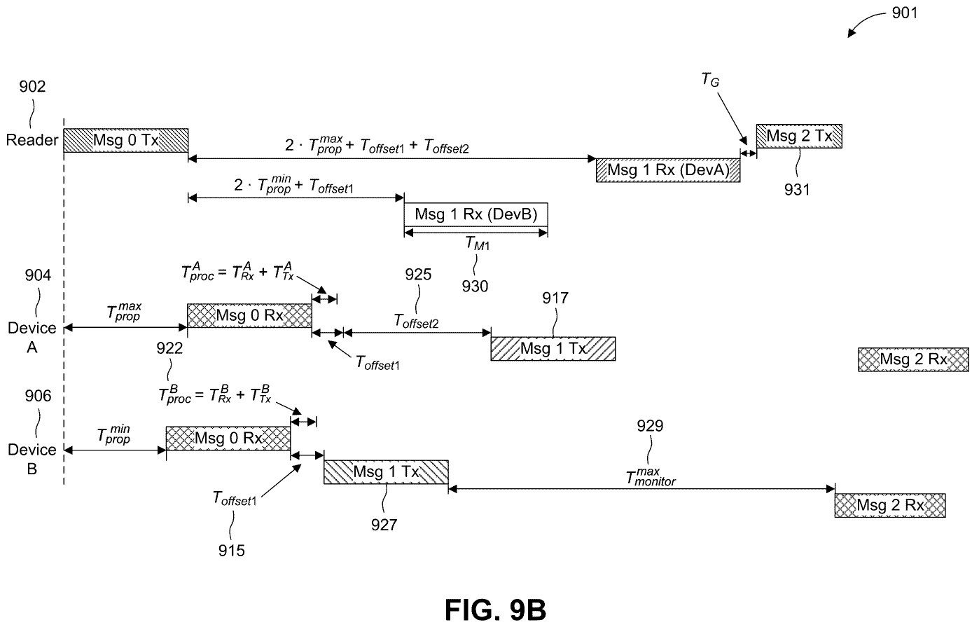

FIG. 9A is a diagram 900 depicting an example collision between resources for transmissions of a random access procedure, in accordance with certain embodiments.

As shown in FIG. 9A, in some examples, a first device (e.g., device A 904) may transmit in a first TDMA occasion triggered by a R2D trigger (e.g., msg0 908) while a second device (e.g., device B 906) may transmit in a second TDMA occasion triggered by the R2D trigger (e.g., msg0 908). For example, device A 904 may be located at the cell edge in relation to a reader 902 and may be associated with a maximum propagation latency time 910. Further, for example, device B 906 may be located closer to the reader 902 and may be associated with a minimum propagation latency time 920. In such examples, the minimum time for device A 904 to transmit in the first msg1 resource (e.g., T_{offset1} 914) is limited by the minimum processing time 912 for the device to receive msg0 908 and prepare transmission of the first msg1 resource 916. Further, for example, T_{offset1} 914 may be defined in reference to the reception time for msg0 908 and may be a pre-defined value based on device processing requirements or subject to device capability. In some examples, the reader 902 uses a guard interval T_{G} 928 for reader processing and transmit/receive switching in between receiving the second msg1 resource 926 and transmitting msg2 930.

In some examples, the minimum start time for the second msg1 resource 926 relative to the first resource (e.g., T_{offset2} 924) is configured to avoid collisions with transmissions in the first msg1 resource 916 while accounting for differences in propagation latency for different devices. As shown in FIG. 9A, when T_{offset2} 924 is not sufficiently large to avoid collision, a device at the cell edge (e.g., device A 904) transmitting msg1 in the first time resource 916 may collide with a device nearer to the reader (e.g., device B 906) when transmitting in the second time resource 926. For example, to avoid such collisions, the second offset time may be constrained by the following inequality

$${T}_{offset 2} \geq 2 \cdot {T}_{p r o p}^{max} + {T}_{M 1} ,$$

where T_{M1} 918 is the transmission duration of msg1 and

$${T}_{p r o p}^{max}$$

is the maximum propagation latency time 910 (e.g., associated with device A 904). Further, for example, T_{offset1} 914 and T_{offset2} 924 may be constrained by a maximum time a device can be expected to transmit in a physical device to reader channel (PD C after receiving in a PRDCH (e.g., a maximum time offset

$${T}_{offset}^{max}$$

). The constraint

$${T}_{offset 1} + {T}_{offset 2} \leq {T}_{offset}^{max} .$$

may be subject to device requirements on latency or capability such that

$${T}_{offset 1} + {T}_{offset 2} \leq {T}_{offset}^{max} .$$

In some examples, both TDMA resources are indicated and, assuming the minimum value for T_{offset2} 924, T_{offset1} 914 is less than or equal to the following expression:

$${T}_{offset}^{max} - 2 \cdot {T}_{prop}^{max} - {T}_{M 1} .$$

In other examples, only a first TDMA resource is indicated and T_{offset1} 914 is less than or equal to

$${T}_{offset}^{max} .$$

FIG. 9B is a diagram 901 depicting example timing relationships for avoiding collisions between resources for transmissions of a random access procedure, in accordance with certain embodiments.

As shown in FIG. 9B, in some examples, the first device (e.g., device A 904 located at the cell edge) may transmit in the second TDMA occasion triggered by a R2D trigger (e.g., msg0 908) while the second device (e.g., device B 906 located closer to the reader 902) may transmit in the first TDMA occasion triggered by the R2D trigger (e.g., msg0 908). In such examples, the minimum time for device B 906 to transmit in the first msg1 resource (e.g., T_{offset1} 915) is limited by the minimum processing time 922 for the device to receive msg0 908 and prepare transmission of the first msg1 resource 927. Further, for example, T_{offset1} 915 may be defined in reference to the reception time for msg0 908 and may be a pre-defined value based on device processing requirements or subject to device capability. In some examples, the reader 902 uses a guard interval T_{G} 928 for reader processing and transmit/receive switching in between receiving the second msg1 resource 917 and transmitting msg2 931.

In some examples, the minimum start time for the second msg1 resource 917 relative to the first resource (e.g., T_{offset2} 925) is configured to avoid collisions with transmissions in the first msg1 resource 927 while accounting for differences in propagation latency for different devices. As shown in FIG. 9B, the second offset time (e.g., T_{offset2} 925) may be constrained by the following inequality:

$${T}_{offset 2} \geq 2 \cdot {T}_{prop}^{max} + {T}_{M 1} ,$$

where T_{M1} 919 is the transmission duration of msg1 and

$${T}_{prop}^{max}$$

is the maximum propagation latency time 910 (e.g., associated with device A 904). Further, for example, T_{offset1} 915 and T_{offset2} 925 may be constrained by a maximum time a device can be expected to transmit PDRCH after receiving PRDCH (e.g., a maximum time offset

$${T}_{offset}^{max}$$

). The constraint

$${T}_{offset}^{max}$$

may be subject to device requirements on latency or capability such that

$${T}_{offset 1} + {T}_{offset 2} \leq {T}_{offset}^{max} .$$

In some examples, both TDMA resources are indicated and, assuming the minimum value for T_{offset2} 925, T_{offset1} 915 is less than or equal to the following expression

$${T}_{offset}^{max} - 2 \cdot {T}_{prop}^{max} - {T}_{M 1} .$$

In other examples, only a first TDMA resource is indicated and T_{offset1} 915 is less than or equal to

$${T}_{offset}^{max} .$$

Additionally, for example, T_{offset2} 925 may be bounded by the maximum monitoring time

$${T}_{monitor}^{max}$$

929 for msg2 931 reception. As shown in FIG. 9B, the earliest a reader 902 can transmit msg2 931 is limited by the maximum propagation latency 910 for a device transmitting in the second msg 1 resource 917. In such examples, the device near the reader (e.g., device B 906) transmitting msg1 in the first time-domain resource 927 may determine its maximum expected monitoring window 929 for msg2 931. Further, for example, the monitoring window 929 may be a pre-defined performance requirement or a device capability, and the reader 902 may configure T_{offset2} 925 to be less than or equal to the following expression:

$${T}_{monitor}^{max} - {T}_{G} - 2 \cdot {T}_{prop}^{max} .$$

In some approaches, using the aforementioned techniques, a reader may indicate a set of multiple msg1 occasions from which a device may choose a single msg1 occasion for transmitting its msg1. Such msg1 occasions may be multiplexed in frequency and/or time. For example, time domain resource multiplexing may be supported through the signaling of two offset values (e.g., T_{offset1} 914 and T_{offset2} 924 of FIG. 9A, T_{offset1} 915 and T_{offset2} 925 of FIG. 9B) indicated by a paging message transmitted to the devices by the reader. Such signaling may account for device processing latency for both R2D trigger reception and msg1 transmission, as well as message size and propagation latency to ensure there are no collisions observed at the reader. However, signaling offsets that are too large may limit spectral efficiency and put unnecessary demand on devices to monitor for msg2 responses. Thus, techniques for determining and signaling efficient signal timing offsets for TDMA of msg1 transmissions of A-IoT random access procedures are desired.

Accordingly, systems and methods are disclosed in the present disclosure for a WTRU to determine and signal resource parameters (e.g., time offsets) for transmissions of an A-IoT random access procedure. In certain representative embodiments, a WTRU (e.g., a reader WTRU) is configured (e.g., semi-statically) with a set of resources by a wireless network (e.g., via a parent gNB) to perform a random access procedure. In certain representative embodiments, the WTRU determines a msg1 resource configuration based on the available configured resources and attempts to complete the random access procedure. In certain representative embodiments, the reader requests an update to the resource allocation from the wireless network (e.g., via the parent gNB) and reconfigures msg1 resources for a re-access attempt based on results of the (e.g., incomplete and/or failed) random access procedure.

In certain representative embodiments, the WTRU performs at least one of the following steps: receiving (e.g., from a parent gNB) a resource allocation to perform a random access procedure for a number of A-IoT devices; determining a configuration for the random access procedure for the A-IoT devices using the configured resource allocation; transmitting a paging message indicating configured parameters for the random access procedure; initiating the random access procedure; monitoring to receive one or more msg1 transmissions of the random access procedure from at least one of the A-IoT devices based on the indicated configured parameters; combinations of the same; or the like. In certain representative embodiments, the WTRU additionally transmits a request for an aperiodic update to the configured resource allocation based on determining that not all A-IoT devices were able to complete the random access procedure. In certain representative embodiments, the WTRU reconfigures time domain msg1 resources (e.g., time offsets) and initiates a re-access procedure with the updated configuration. For example, the WTRU may determine that not all A-IoT devices were able to complete the random access procedure due to contention failure or message reception failure. Further, for example, the WTRU reconfigures the time domain msg1 resources based on a determined failure rate from one or more previous random access procedure attempts.

For example, the configured resource allocation may be a semi-static resource allocation. Further, for example, configured resource allocation may indicate at least one of the following: a time and/or frequency resource allocation; a periodicity; an offset within the configured period; combinations of the same; or the like.

For example, the WTRU may determine the configuration for the random access procedure by determining at least one of the following: a number of ALOHA slots for random access selection; frequency domain resources for frequency division multiplexed msg1 transmission occasions; a number of time domain msg1 resources (e.g., 1 or 2 time domain resources) that are available for A-IoT device transmission; a start time of one or more time domain msg1 resources available for A-IoT devices to transmit msg1; combinations of the same; or the like. Further, for example, if one time domain msg1 resource is configured, T_{offset1} may be indicated such that the following inequality is satisfied:

$${T}_{proc}^{max} \leq {T}_{offset 1} \leq {T}_{offset}^{max} .$$

Additionally, for example, if two time domain msg1 resources are configured, T_{offset1} may be indicated such that

$${T}_{proc}^{max} \leq {T}_{offset 1} \leq {T}_{offset}^{max} - 2 \cdot {T}_{prop}^{max} - {T}_{M 1} ,$$

and T_{offset2} may be indicated such that 2

$${T}_{prop}^{max} + {T}_{M 1} \leq {T}_{offset 2} \leq {T}_{monitor}^{max} - {T}_{G} - 2 \cdot {T}_{prop}^{max} .$$

In accordance with certain embodiments of the present disclosure, some relevant terminology is defined as follows.

In the present disclosure, the terms “device,” “A-IoT,” and “UE” may be used interchangeably to mean the A-IoT device that is being inventoried and/or queried by the reader. The term reader may refer to the entity which queries the A-IoT device, either directly, or via an intermediate WTRU (e.g., intermediate node 306 of topology 300 of FIG. 3). The term “reader” may also refer to the intermediate WTRU. Consequently, the term “reader” may refer to a network node or a WTRU, depending on the context and/or the topology.

In the present disclosure, the terms “reader,” “network,” and “intermediate WTRU” may be used interchangeably to mean the reader. In some examples, there may exist a tradeoff between the number of resources for random access, the size of a random ID (e.g., the number of unique IDs that can be selected), and the power consumption associated with the devices. In such examples, a large number of resources may not be preferred because the time required for the inventory procedure would increase. Increasing the size of the random ID or using less resources may shorten the time required for the inventor procedure but may result in increased power consumption. In some examples, if the same size of the random ID is used in all cases, the system may consume A-IoT device power unnecessarily.

In the present disclosure, the term “inventory” may refer to the overall procedure of a reader triggering access by multiple devices using a sequence of messages (e.g., similar to the query procedure for radio frequency identification (RFID)). The inventory procedure may refer to a single round of attempts to have each A-IoT device respond or attempt to respond with its access ID or perform a random access channel (RACH) procedure. The inventory procedure may additionally or alternatively refer to a set of access occasions which either corresponds to no devices responding or at least one device responding within the access occasion. Inventory procedures may occur in a similar manner to RFID procedures. The inventory procedure described herein may also correspond to a query procedure and/or paging procedure.

In the present disclosure, an occasion refers to an opportunity for device transmission that may be delimited by the transmission of a message (e.g., QueryRep message or the like). For example, an A-IoT device may perform transmission in an occasion by performing an A-IoT transmission in a defined time following a QueryRep message associated with the A-IoT transmission. Further, for example, an occasion may include a time aspect and/or a frequency aspect. Also, for example, an A-IoT device may determine an occasion as a transmission following a specific QueryRep message in one of a number of frequencies. In the present disclosure, selection of an occasion may refer equivalently to selection of only a time resource and/or only a frequency resource.

In the present disclosure, any reference to time and/or time resources may be associated with an absolute time measurement (e.g., seconds, slots, frames, or the like). Additionally, or alternatively, time may refer to a number of executions of a procedure (e.g., possibly triggered by a reader). For example, the time may refer to a number of inventory procedures, a number of accesses or RACH procedures, or the like). Herein, time and/or time resources may refer to a number of messages, possibly of a specific type, or containing specific information.

In the present disclosure, configuration and/or pre-configuration may refer to any configuration information received by a message (e.g., a radio resource control (RRC) message, a medium access control element (MAC-CE), a physical (PHY) layer signal, a protocol data unit (PDU), a control PDU associated with any or a new protocol layer, or the like) received from either a network node (e.g., gNB), or from another device or WTRU.

An A-IoT device herein may be configured by the reader, where the reader may be a network node or a WTRU. For example, the WTRU may derive the device configuration itself or receive the device configuration from the network, in which case, the device configuration is being relayed from the network to the device by the WTRU. In some examples, a WTRU configuration (for a WTRU 306 in topology 300 of FIG. 3) may be received from a network node (e.g., the gNB).

In the present disclosure, the term “resource” (e.g., when referring to the A-IoT interface) may refer to at least one of the following: a (e.g., traditional) time/frequency resource; a time resource; a frequency resource, which may be available at different times; a time resource; combination of the same; or the like. For example, the time resource (e.g., possibly limited to one or more frequencies or frequency ranges) may start from the transmission of a reader message, and last either a maximum period of time, or until the next transmission by the reader, possibly of a specific message.

In accordance with certain embodiments of the present disclosure, configuration of network resources for a WTRU (e.g., reader WTRU) is described as follows.

In certain representative embodiments, a WTRU (e.g., reader WTRU) receives a configuration from the wireless network indicating the availability of network resources for the WTRU to complete a paging procedure (e.g., random access procedure). For example, the configuration may indicate an aperiodic time domain resource allocation. Further, for example, the configuration may include an indication of a starting time for the paging procedure, which may be indicated by at least one of: a frame number, a subframe number within a frame, a slot number within a subframe, a symbol number within a slot, combinations of the same, or the like. Moreover, for example, the start time may be indicated in units of time (e.g., milliseconds, microseconds, or the like) relative to a reference time. The reference time may be pre-defined (e.g., the end of the slot in which the configuration is received) or indicated in the configuration. Additionally, for example, the configuration may include a duration or an ending time for time domain resource allocation, which may be indicated in units of frames, subframes, slots, symbols, milliseconds, microseconds, or the like.

In certain representative embodiments, the time domain resources for the paging procedure may be configured for use on a periodic basis. For example, in addition to receiving an indication a starting time and duration for the paging procedure, the WTRU may also receive an indication for a periodic reuse of the configured time domain resources. Further, for example, the indication for periodic reuse may indicate a period in units of frames, subframes, slots, symbols or the like. Also, for example, the indication for periodic reuse may indicate a time offset within the period in units of frames, subframes, slots, symbols or the like.

In certain representative embodiments, the time domain resources for the paging procedure may be configured for use on a semi-persistent basis. For example, the WTRU may receive a configuration indicating an inactive periodic resource allocation from the wireless network. Further, for example, when the WTRU receives a separate activation message (e.g., via MAC-CE) or downlink control information (DCI), or the like) from the wireless network, the WTRU may activate the inactive periodic resource allocation and use the corresponding resources as configured. In some embodiments, the WTRU ceases to use the configured resource allocation upon receiving a separate de-activation indication (e.g., via MAC-CE or DCI) from the wireless network. Also, for example, the WTRU may also activate the inactive periodic resource allocation implicitly by identifying an event rather than an explicit indication. In one example, a WTRU may detect proximity to a plurality of A-IoT devices and, based on the detected proximity, activate the inactive periodic resource allocation for an inventory procedure of the detected devices. In such examples, when a WTRU activates a semi-persistent resource allocation based on an identified event, the WTRU may transmit a separate message to the wireless network to indicate that it is using the configured resource allocation.

In certain representative embodiments, the configuration may indicate a frequency domain resource allocation. For example, the frequency domain resource allocation may be indicated by at least one of: a bandwidth; common resources blocks (CRBs); a bandwidth part (BWP); part of a bandwidth part (e.g., indicated in physical resource blocks (PRBs), or subcarriers); combinations of the same; or the like. Further, for example, an indication of bandwidth may include a reference subcarrier spacing (SCS) for determining the bandwidth of individual PRBs. The SCS may be determined implicitly (e.g., a SCS for a frequency domain resource allocation in a BWP is determined based on the SCS configured for the BWP) or indicated explicitly. Also, for example, the frequency domain resource allocation may include a starting point (e.g., indicated as a SCS number, a CRB number, a PRB number, or the like) relative to a reference point (e.g., indicated reference point, predefined reference point). The frequency domain resource allocation may be constant for an entire allocated time domain resource or the frequency domain resource allocation may vary. For example, M PRBs may be allocated in the first instance of a periodic resource allocation, and N PRBs may be allocated in the second instance of the periodic resource allocation.

In certain representative embodiments, the WTRU may receive an initial indication of available resources for a paging procedure and is configured to indicate when it has completed the paging procedure. For example, a WTRU is configured with a periodic resource allocation for completing a paging procedure. In some embodiments, the WTRU may be expected to continue the paging procedure within the periodic resource allocation until no further A-IoT devices are identified. In such embodiments, after successful completion of the paging procedure, the WTRU may transmit an indication to the wireless network (e.g., via a parent gNB) that the paging procedure was concluded successfully. The WTRU may subsequently consider the periodic resource allocation de-activated.

In certain representative embodiments, the WTRU may provide an indication to the wireless network (e.g., via a parent gNB) that the resource allocation provided for the paging procedure is insufficient and/or that the paging procedure has not successfully been completed. For example, a WTRU may receive an aperiodic resource allocation for completing a paging procedure. Further, for example, the WTRU may attempt to use the allocated resources to complete the paging procedure. During the paging procedure, the WTRU may determine that one or more A-IoT devices have failed to successfully complete their procedure within the allocated resources. In such examples, the WTRU may send an indication to the wireless network (e.g., via the parent gNB) indicating that the paging procedure was not completed successfully and/or requesting additional resources.

In accordance with certain representative embodiments of the present disclosure, WTRU scheduling of allocated resources for a paging procedure is described as follows.

In certain representative embodiments, a WTRU which has received a resource allocation for completing a paging procedure may send an initial paging message to a plurality of A-IoT devices to schedule R2D and D2R messages of the paging procedure within the resource allocation received from the network.

For example, the initial paging message may indicate a number of ALOHA slots within a slotted ALOHA medium access control (MAC) algorithm configured for paging procedures. Further, for example, the initial paging message may indicate a number of R2D slot triggers (e.g., msg0, R2D trigger 708 of FIG. 7) that the WTRU will transmit to the plurality of A-IoT devices. Moreover, for example, the initial paging message may indicate a number of time and/or frequency domain resources that are allocated for each A-IoT device to send a response message (e.g., msg1 710 of FIG. 7) to each msg0 transmission.

For example, the initial paging message may include a service identifier used to indicate all R2D and D2R messages associated with the same paging procedure (e.g., A-IoT random access procedure). Further, for example, the initial paging message may include an indication of whether the paging procedure is for contention-based random access (CBRA) or contention-free random access (CFRA).

For example, the initial paging message may include a format for msg1 to be transmitted by an A-IoT device. Further, for example, the format information may include at least one of: a modulation format (e.g., on-off-keying (OOK), binary phase-shift keying (BPSK), or the like); line encoding format (e.g., Manchester encoding, Miller encoding, or the like); msg1 contents (e.g., energy status information, higher-layer device identifiers, and/or lower layer random IDs); a channel coding format and/or rate (e.g., ⅓ rate convolutional encoder); a block level repetition rate; transmit power; combinations of the same; or the like.

For example, the initial paging message may indicate a number of frequency domain resources, Y, for an A-IoT device to select for msg1 transmission. Further, for example, an initial paging message may indicate that Y=4 frequency domain resources are allocated for a device to transmit msg1 in response to each msg0 received. Moreover, for example, the WTRU may indicated the frequency domain resources as a number of supported repetition factors the A-IoT device may be expected to use to perform a small frequency shift relative to a baseband transmission. In some examples, the WTRU may indicate the repetition factors as a scalar multiple relative to a chip duration used for the initial paging message.

In certain representative embodiments, the frequency domain resource allocation is the same for each time domain resource allocation. In certain representative embodiments, the frequency domain resource allocation may include a or each time domain resource allocation may indication a different separate indication of center frequency and/or bandwidth for each time domain resource allocation.

In accordance with certain embodiments of the present disclosure, WTRU indication of time domain resources for msg1 transmission is described as follows.

In certain representative embodiments, the initial paging message includes an indication of a number of time domain resources, X, for a device to select for msg1 transmission. For example, the initial paging message may indicate that X=2 time domain resources are allocated for an A-IoT device to transmit msg1 in response to each received msg0. Further, for example, the initial paging message may indicate a start time for the A-IoT device to transmit in each time domain resource. Moreover, for example, the initial paging message may indicate a first time offset, T_{offset1}, relative to the end of the reception of msg0 for msg1 transmission using the first time domain occasion, and a second time offset, T_{offset2}, relative to the end of T_{offset1}, for msg1 transmission when using the second time domain occasion.

For example, the WTRU may indicate each time offset for msg1 transmission explicitly in units of milliseconds, bits, chips, or the like. Further, for example, the WTRU may indicate each timing offset as a function of a number of other implicitly indicated parameters and/or pre-defined values. In some examples, X=2 time domain resources are configured, and T_{offset1} may be indicated as a function of factors including at least one of: an expected sampling frequency offset between the WTRU and the A-IoT device; a minimum A-IoT device processing time for receiving msg0; a minimum A-IoT device processing time for transmitting msg1; a maximum supported offset of an A-IoT device for transmitting after receiving an R2D message; a maximum expected propagation latency between the WTRU and A-IoT device, a duration of the msg1 transmission; combinations of the same; or the like. In some examples, T_{offset2} may be indicated as a function of factors including at least one of: an expected sampling frequency offset between the WTRU and A-IoT device; a maximum expected propagation latency between the WTRU and A-IoT device; a WTRU transmit/receive switching time; a msg1 duration; a maximum supported window of an A-IoT device for monitoring for an R2D message after transmitting a D2R message; combinations of the same; or the like. In such examples, factors such as minimum A-IoT device processing times, maximum supported offsets for transmitting D2R after receiving R2D, and maximum supported monitoring windows for R2D reception after transmitting D2R may be pre-defined or determined based on an A-IoT device capability. In such examples, factors such as maximum propagation latency may be determined implicitly (e.g., based on expected coverage for the WTRU and/or an indoor or outdoor usage scenario determined independently by the A-IoT device or indicated by the WTRU). In such examples, factors such a WTRU transmit/receive switching time may be pre-defined or indicated to the A-IoT devices as a WTRU capability.

In certain representative embodiments, a WTRU may indicate a range of values (e.g., time offset values) to each A-IoT device and expect that the A-IoT device will select the correct value from the range based on local device measurements. For example, an A-IoT device that measures poor link quality when receiving msg0 from a WTRU may select the offset values from the range that corresponding to worst case propagation latency from the WTRU to the A-IoT device.

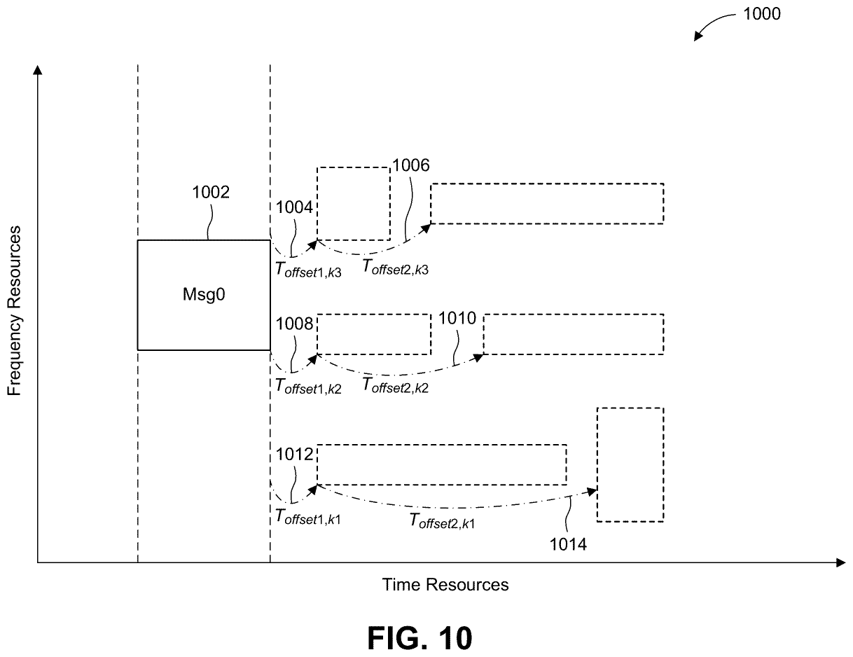

FIG. 10 is a diagram 1000 depicting example time domain offset indications varying across different frequency resources, in accordance with certain embodiments;

In certain representative embodiments, timing offsets may be assumed to be the same for each frequency resource allocated for msg1 response. In certain representative embodiments, as shown in FIG. 10, timing offsets may be indicated separately for each frequency domain resource. In such embodiments, when a separate indication is provided for each frequency domain resource, the implicit assumptions for determining the timing offset may be differ across frequency domain resources as well.

For example, the WTRU may transmit a msg0 1002 to the plurality of A-IoT devices as part of a paging procedure configured with X=2 time domain resources and Y=3 frequency domain resources. Further, for example, characteristics of the frequency domain resources (e.g., center frequency, bandwidth) may differ across time domain resources. Likewise, for example, characteristics of the time domain resources (e.g., start time, duration) may differ across frequency domain resources. In such examples, the WTRU may indicate separate time offset for each frequency resource. In one example, the WTRU may indicate T_{offset1,k1} 1012 and T_{offset2,k1} 1014 for a first frequency domain resource, T_{offset1,k2} 1008 and T_{offset2,k2} 1010 for a second frequency domain resource, and T_{offset1,k3} 1004 and T_{offset2,k3} 1006 for a third frequency domain resource.

In accordance with certain embodiments of the present disclosure, WTRU response to multiple msg1 transmissions in the same slot is described as follows.

In certain representative embodiments, a WTRU may send a single response (e.g., msg2) to msg1 transmissions of multiple A-IoT devices. For example, the msg1 response may include an ID that an A-IoT device included in its msg1 transmission so that the A-IoT device may identify that it is one of the A-IoT devices intended to receive the response. Further, for example, msg2 may include an indication of whether the A-IoT device is expected to transmit another message (msg3) or receive additional data from the WTRU.

For example, a WTRU may indicate (e.g., via msg 2) that an A-IoT device is expected to transmit msg3 to the WTRU. Further, for example, the msg2 indication may include a format for msg3 to be transmitted by the A-IoT device. Moreover, for example, the format information may include at least one of: a modulation format (e.g., OOK, BPSK, or the like); a line encoding format (e.g., Manchester encoding, Miller encoding, or the like); msg1 contents including data type requests (e.g., memory read, device status, or the like); a message size (e.g., transport block size and relevant cyclic redundancy check (CRC) attachment); a channel coding format and/or rate (e.g., ⅓ rate convolutional encoder); a block level repetition rate; a transmit power; combinations of the same; or the like. Additionally, for example, the WTRU may expect a msg3 transmission to be formatted based on a pre-defined rule if an indication of any parameter is not sent. In such an example, the A-IoT may use the modulation, coding and/or repetition factors.

In certain representative embodiments, the initial paging message includes an indication of frequency domain resources for an A-IoT device to select for msg1 transmission. For example, such frequency domain resources may be indicated as a number of supported repetition factors the device may be expected to use to perform a small frequency shift relative to a baseband transmission. Further, for example, a msg2 transmission may indicate that the A-IoT device should transmit msg3 with a repetition factor, R, relative to a baseband transmission. In some embodiments, the WTRU indicates the repetition factors as a scalar multiple relative to the chip duration used for the initial paging message. In some embodiments, the WTRU expects a msg3 transmission to be made on a frequency domain resource based on a pre-defined rule (e.g., if an indication of frequency domain resources is not sent). For example, an A-IoT device may reuse the small frequency shift used for its msg1 transmission if no indication of frequency domain resources is provided by the WTRU.

In certain representative embodiments, if a WTRU has received more msg1 transmissions in a slot than available msg3 resources for transmission, the WTRU may select a subset of A-IoT devices to provide a response to in msg2. In certain representative embodiments, the WTRU may determine that a collision has occurred and A-IoT devices who do not receive a msg2 response will still need to complete the paging procedure.

In accordance with certain embodiments of the present disclosure, WTRU indication of paging conclusion to the network is described as follows.

In certain representative embodiments, a WTRU that has both responded to every msg1 transmission and either received every corresponding msg3 transmission or successfully transmitted additional data to every A-IoT device, determines that the paging procedure is complete. In such embodiments, the WTRU may transmit an indication to the wireless network (e.g. via parent gNB) indicating successful completion of the paging procedure. For example, upon transmitting the indication of paging procedure completion, the WTRU may assume that the resources allocated by the wireless network for the paging procedure are no longer available. Further, for example, the WTRU may transmit the indication of paging procedure completion as control information in physical uplink control channel (PUCCH) multiplexed with other control information.

For example, the format (e.g., modulation and coding, relevant control information, payload size, relevant device identifiers, relevant message identifiers, or the like) of the indication of paging procedure completion may have been previously configured by the wireless network in a separate message. Additionally, for example, the schedule for the indication of paging procedure completion, including identification of the PUCCH resource in which the WTRU should transmit the indication, may have been previously configured by the network in a separate message. Further, for example, the WTRU may receive a configuration from the wireless network indicating that the indication of paging procedure completion should be multiplexed with user-plane data (e.g., in a physical uplink shared channel (PUSCH) resource). Also, for example, the WTRU may receive a prioritization for the indication of paging procedure completion that instructs the WTRU as to when the indication should be prioritized over other data types for inclusion in transmissions (e.g., to the wireless network).

In accordance with certain embodiments of the present disclosure, WTRU indication of insufficient resources to complete paging is described as follows.

In certain representative embodiments, a WTRU may determine that the paging procedure is complete based on identifying at least one of the following: not every msg1 transmission has been received; not every corresponding msg3 was received successfully; additional data to every A-IoT device was not transmitted successfully; combinations of the same or the like. For example, the WTRU may transmit an indication to the wireless network (e.g. via parent gNB) indicating unsuccessful completion of the paging procedure. Further, for example, the WTRU may request additional resources for the completion of the paging procedure. Moreover, for example, the reader may request one or more of additional frequency domain resources, additional time domain resources, extension of the periodic resource allocation, or the like. Also, for example, the reader may transmit the indication of unsuccessful paging completion as control information in PUCCH multiplexed with other control information.

For example, the format (e.g., modulation and coding, relevant control information, payload size, relevant device identifiers, relevant message identifiers, or the like) of the indication of unsuccessful paging completion may have been previously configured by the network in a separate message. Further, for example, scheduling the indication of unsuccessful paging completion, including identification of the PUCCH resource in which the WTRU should transmit the indication, may have been previously configured by the wireless network in a separate message. Moreover, for example, the WTRU may receive a configuration from the wireless network that the indication of unsuccessful paging procedure completion should be multiplexed with user-plane data (e.g., in a PUSCH resource). Also, for example, the WTRU may also receive a prioritization for the indication of unsuccessful paging completion that instructs the WTRU as to when the indication should be prioritized over other data types for inclusion in transmissions (e.g., to the wireless network).

In accordance with certain embodiments of the present disclosure, WTRU indication of paging resource re-allocation for re-access to A-IoT devices is described as follows.

In certain representative embodiments, a WTRU receives additional resources for the completion of paging procedure and initiates a re-access procedure for the remaining A-IoT devices. For example, the WTRU may transmit a re-access paging message indicating the same service ID used in the initial paging procedure. Further, for example, the WTRU may reconfigure R2D and D2R resources for the re-access procedure by indicating at least one of: one or more ALOHA slots; a number and type of available IDs for use in random access procedure; new msg1 formatting information; a new indication of available msg1 resources for each ALOHA slot; combinations of the same; or the like. Moreover, for example, the WTRU may explicitly indicate updates to the paging procedure in the re-access paging message based on identifying at least one of: changes to the allocated resources from the wireless network; a number of successful and unsuccessful random access attempts in the initial paging procedure; a suboptimal configuration of msg1 resources of the initial paging procedure; combinations of the same; or the like. Also, for example, the WTRU may implicitly indicate updated A-IoT device behavior (e.g., based on failure to receive a msg2 response in the initial paging procedure). In some embodiments, an A-IoT device that did not receive a msg2 response in the initial paging procedure, may assume the msg1 resource configuration falls back to a default configuration for the re-access procedure.

In accordance with certain embodiments of the present disclosure, WTRU indication of resource re-allocation to A-IoT devices during an active paging procedure is described as follows.

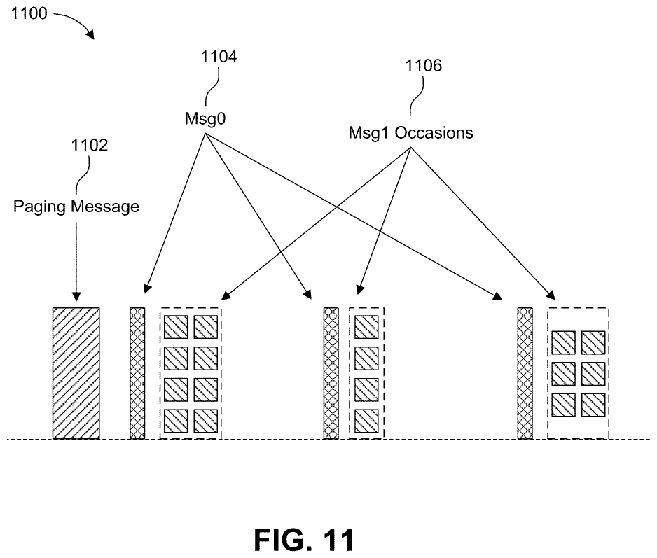

FIG. 11 is a diagram depicting an example of updating resource parameters during a random access procedure 1100, in accordance with certain embodiments;

As shown in FIG. 11, in certain representative embodiments, a WTRU that has not completed a paging procedure (e.g., random access procedure 1100) determines that the msg1 resource allocation is suboptimal. For example, the WTRU may determine that the msg1 resource allocation is suboptimal based on at least one of: a failure to recover a msg1 transmission successfully, identifying an unwanted number of collisions in msg1 resources, combinations of the same, or the like. Further, for example, the WTRU may indicate an update to the msg1 allocation for some or all of the remaining ALOHA slots of the paging procedure 1100 configured by a paging message 1102. Moreover, for example, the WTRU may include an update to the msg1 resource allocation by appending update configuration parameters to an R2D trigger (e.g., msg0 1104) within the paging procedure.

For example, the A-IoT devices may assume that one or more successive slots are re-configured based on the updated parameters appended to the msg0 1104. Further, for example, the number of successive slots may be indicated explicitly in the appended control information or assumed based on a pre-defined rule. Moreover, for example, a WTRU may send a paging adjust message in addition to the msg0 1104 transmissions that are being sent. In some embodiments, the paging adjust message may be assumed by the A-IoT devices to overwrite the existing configuration for the current paging procedure. Also, for example, an A-IoT device receiving a paging update may assume that the slot counting rule for an updated paging procedure is changed based on a pre-defined rule for the updated resources.

For example, in paging procedure 1100, an A-IoT device counting ALOHA slots configured with Y=4 frequency domain resources and X=2 time domain resources for msg1 transmission occasions 1106 may count by one (e.g., time domain resource) after receiving an update for the paging procedure indicating Y=4 frequency domain resources and X=1 time domain resources. Further, for example, the update for the paging procedure may be transmitted to the A-IoT device via an update paging message, a msg0 1104 instance, or a separate indication from the WTRU. Similarly, for example, the A-IoT device may further alter its slot counting procedure upon receiving an update for the paging procedure indicating Y=3 frequency domain resources and X=2 time domain resources.

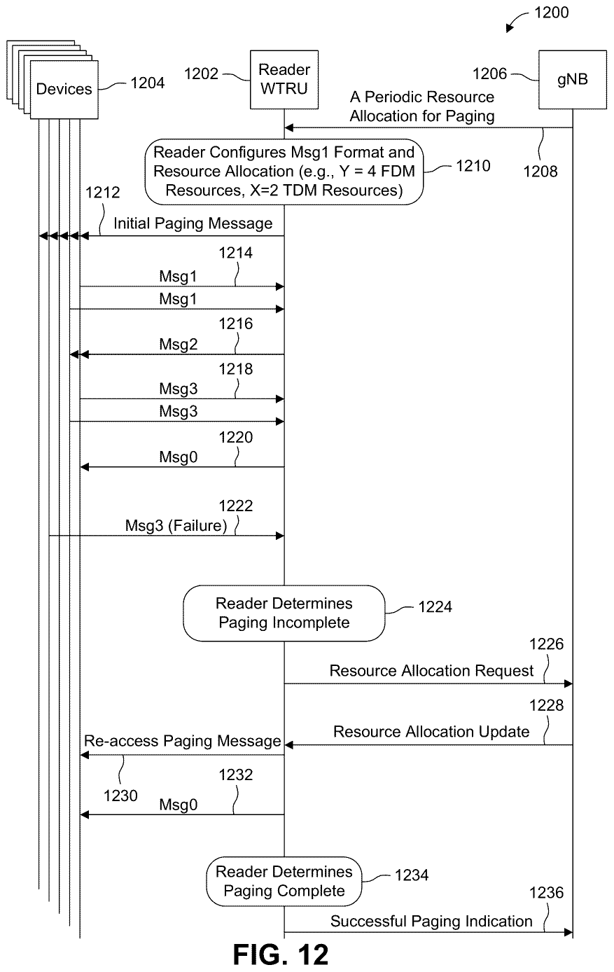

FIG. 12 is a flowchart of an illustrative method for reallocating resources for a random access procedure, in accordance with certain embodiments.

In certain representative embodiments, as shown in FIG. 12, a process 1200 is performed by a WTRU 1202 (e.g., WTRU 102 of FIGS. 1A-1D, intermediate node 306 of FIG. 3, reader 702 of FIG. 7), a gNB (e.g., base stations 114a, 114b of FIG. 1A, eNode-Bs 160a-c of FIG. 1B, gNBs 180a-c of FIG. 1D) of a wireless network (e.g., RAN 104 and 113 of FIGS. 1A-D and/or core network 106 and 115 of FIGS. 1A-D), and/or one or more A-IoT devices 1204 (e.g., device 304 of FIG. 3, device 704 of FIG. 7, devices A 904 and B 906 of FIGS. 9A-B), which may be implemented in communications system 100 illustrated in FIG. 1A-1D.

At step 1208, the gNB 1206 transmits a periodic resource allocation for a paging procedure to the WTRU 1202. At step 1210, the WTRU 1202 configures a msg1 format and resource allocation for the one or more A-IoT devices 1204. For example, the WTRU 1202 may determine Y=4 frequency domain resources and X=2 time domain resources for msg1 transmission occasions. At step 1212, the WTRU 1202 transmits the initial paging message to the one or more A-IoT devices 1204. For example, the initial paging message may include the msg1 format and/or the resource allocation determined in step 1210. At step 1214, the one or more A-IoT devices 1204 transmit a msg1 to the WTRU 1202. For example, the msg1 transmissions may be transmitted using resources indicated by the initial paging message. Further, for example, the msg1 transmissions may include device IDs of the one or more A-IoT devices 1204. At step 1216, the WTRU 1202 transmits a msg2 to the one or more A-IoT devices 1204. For example, the msg2 may include echoes of the device IDs received in the msg1 transmissions and/or a request for msg3 transmissions. At step 1218, the one or more A-IoT devices 1204 transmit a msg3 to the WTRU 1202. For example, the msg3 may include upper-layer data associated with the one or more A-IoT devices 1204. At step 1220, the WTRU 1202 sends one or more additional msg0 instances to the one or more A-IoT devices 1204.

At step 1222, the one or more A-IoT devices 1204 sends a msg3 instance indicating failure of the paging process to the WTRU 1202. At step 1224, the WTRU 1202 determines, based on the msg3 instance from step 1222, that the paging procedure is incomplete. At step 1226, the WTRU 1202 sends a resource allocation request 1226 to the gNB 1206 (e.g., based on determining that the paging procedure is incomplete in step 1224). At step 1228, the gNB 1206 transmits a resource allocation update to the WTRU 1202. At step 1230, the WTRU 1202 transmits a re-access paging message 1230 to the one or more A-IoT devices 1204. For example, the re-access paging message may indicate an updated msg1 format and/or resource allocation (e.g., determined by the WTRU 1202 based on the updated resource allocation received in step 1228). At step 1232, the WTRU 1202 may send one or more msg0 instances to the one or more A-IoT devices 1204. At step 1234, the WTRU determines that the paging procedure is complete. At step 1236, based on determining that the paging procedure is complete, the WTRU transmits a successful paging indication to the gNB 1206.

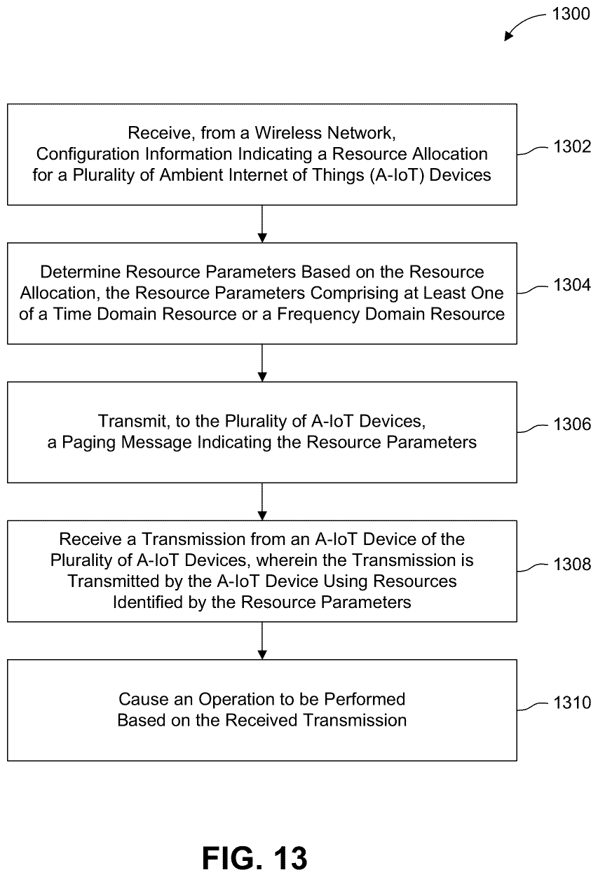

FIG. 13 is a flowchart of an illustrative method performed by a WTRU for allocating time domain resources for A-IoT devices.

In certain representative embodiments, as shown in FIG. 13, a process 1300 is performed by a WTRU (e.g., WTRU 102 of FIGS. 1A-1D, intermediate node 306 of FIG. 3, reader 702 of FIG. 7, WTRU 1202 of FIG. 12) in connection with a wireless network (e.g., RAN 104 and 113 of FIGS. 1A-D and/or core network 106 and 115 of FIGS. 1A-D, via gNB 1206 of FIG. 12), which may be implemented in communications system 100 illustrated in FIG. 1A-1D.

At step 1302, the WTRU receives, from the wireless network, configuration information indicating a resource allocation for a plurality of A-IoT devices (e.g., device 304 of FIG. 3, device 704 of FIG. 7, devices A 904 and B 906 of FIGS. 9A-B, A-IoT devices 1204 of FIG. 12). In some embodiments, the configuration information includes at least one of: a time domain resource allocation; a frequency domain resource allocation; a periodicity; an offset within a configured period; combinations of the same; or the like.

At step 1304, the WTRU determines resource parameters based on the resource allocation. In some embodiments, the resource parameters include at least one of a time domain resource or a frequency domain resource. In some embodiments, the WTRU determines a time offset corresponding to the time domain resource. For example, the time offset may be based on at least one of: a minimum processing time associated with the plurality of A-IoT devices or a maximum time offset associated with the plurality of A-IoT devices. In some embodiments, the resource parameters include a first time domain resource and a second time domain resource and the WTRU determines a first time offset corresponding to the first time domain resource and a second time offset corresponding to the second time domain resource. For example, the first time offset may be based on at least one of: a minimum processing time associated with the plurality of A-IoT devices, a sampling frequency offset between the WTRU and the plurality of A-IoT devices, a maximum time offset associated with the plurality of A-IoT devices, a maximum propagation latency associated with the plurality of A-IoT devices, or a transmission duration associated with the plurality of A-IoT devices. Further, for example, the second time offset may be based on at least one of: a maximum monitoring window associated with the plurality of A-IoT devices, a receive/transmit switching time associated with the WTRU, the maximum propagation latency associated with the plurality of A-IoT devices, the sampling frequency offset between the WTRU and the plurality of A-IoT devices, or the transmission duration associated with the plurality of A-IoT devices.

At step 1306, the WTRU transmits, to the plurality of A-IoT devices, a paging message indicating the resource parameters. In some embodiments, transmitting the paging message (e.g., paging message 706 of FIG. 7, paging message 1102 of FIG. 11, initial paging message 1212 of FIG. 12) is a part of a random access procedure for the plurality of A-IoT devices. In some embodiments, the paging message indicates the time offset corresponding to the time domain resource. In some embodiments, the paging message indicates a range of time offset values corresponding to the time domain resource. In some embodiments, a time offset value from the range of time offset values is selected by the A-IoT device based on one or more local measurements performed by the A-IoT device and the transmission is transmitted by the A-IoT device based on the selected time offset value.

At step 1308, the WTRU receives a transmission from an A-IoT device of the plurality of A-IoT devices. In some embodiments, the transmission is transmitted by the A-IoT devices using resources identified by the resource parameters. For example, the transmission may be a msg1 transmission of the random access procedure (e.g., msg1 710 of FIG. 7, msg1 808 of FIG. 8, msg1 1214 of FIG. 12).

At step 1310, the WTRU causes the operation to be performed based on the received transmission. In some embodiments, causing the operation to be performed includes performing at least one of the following steps in relation to a re-access procedure: determining, based on the received transmission, that the resource allocation is not sufficient to complete the random access procedure for the plurality of A-IoT devices; transmitting, to the wireless network, a request to update the resource allocation; receiving, from the wireless network, updated configuration information indicating an updated resource allocation for the plurality of A-IoT devices; determining updated resource parameters based on the updated resource allocation; transmitting, to the plurality of A-IoT devices, a re-access paging message indicating the updated resource parameters; combinations of the same; or the like. In some embodiments, causing the operation to be performed includes performing at least one of the following steps in relation to resource parameter adjustment: determining, based on the received transmission, to adjust the resource parameters; adjusting, based on the resource allocation, the resource parameters; or transmitting, to the plurality of A-IoT devices, an indication of the adjusted resource parameters; combinations of the same; or the like. In some embodiments, determining to adjust the resource parameters is based on at least one of: identifying one or more collisions associated with the resources used to transmit the received transmission, or identifying a failure to recover the received transmission. In some embodiments, causing the operation to be performed includes determining, based on the received transmission, that the random access procedure was completed successfully for the plurality of A-IoT devices, and transmitting, to the wireless network, an indication to de-activate the resource allocation.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network, configuration information indicating a resource allocation for a plurality of ambient internet of things (A-IoT) devices;
determining resource parameters based on the resource allocation, the resource parameters comprising at least one of a time domain resource or a frequency domain resource;
transmitting, to the plurality of A-IoT devices, a paging message indicating the resource parameters;
receiving a transmission from an A-IoT device of the plurality of A-IoT devices, wherein the transmission from the A-IoT device uses resources identified by the resource parameters; and
causing an operation to be performed based on the received transmission.

2. The method of claim 1, wherein:
the resource parameters comprise the time domain resource; and
the paging message indicates a time offset corresponding to the time domain resource.

3. The method of claim 2, wherein the time offset is based on at least one of:
a minimum processing time associated with the plurality of A-IoT devices; or
a maximum time offset associated with the plurality of A-IoT devices.

4. The method of claim 1, wherein:
the resource parameters comprise a first time domain resource and a second time domain resource; and
the paging message indicates a first time offset corresponding to the first time domain resource and a second time offset corresponding to the second time domain resource.

5. The method of claim 4, wherein:
the first time offset is based on at least one of:
a minimum processing time associated with the plurality of A-IoT devices;
a sampling frequency offset between the WTRU and the plurality of A-IoT devices;
a maximum time offset associated with the plurality of A-IoT devices;
a maximum propagation latency associated with the plurality of A-IoT devices; or
a transmission duration associated with the plurality of A-IoT devices; and
the second time offset is based on at least one of:
a maximum monitoring window associated with the plurality of A-IoT devices;
a receive/transmit switching time associated with the WTRU;
the maximum propagation latency associated with the plurality of A-IoT devices;
the sampling frequency offset between the WTRU and the plurality of A-IoT devices; or
the transmission duration associated with the plurality of A-IoT devices.

6. The method of claim 1, wherein the paging message indicates a range of time offset values corresponding to the time domain resource.

7. The method of claim 1, wherein transmitting the paging message is a part of a random access procedure for the plurality of A-IoT devices, and causing the operation to be performed comprises:
determining, based on the received transmission, that the resource allocation is not sufficient to complete the random access procedure for the plurality of A-IoT devices;
transmitting, to the wireless network, a request to update the resource allocation;
receiving, from the wireless network, updated configuration information indicating an updated resource allocation for the plurality of A-IoT devices;
determining updated resource parameters based on the updated resource allocation; and
transmitting, to the plurality of A-IoT devices, a re-access paging message indicating the updated resource parameters.

8. The method of claim 1, wherein causing the operation to be performed comprises:
determining, based on the received transmission, to adjust the resource parameters;
adjusting, based on the resource allocation, the resource parameters; and
transmitting, to the plurality of A-IoT devices, an indication of the adjusted resource parameters.

9. The method of claim 8, wherein determining to adjust the resource parameters is based on at least one of:
identifying one or more collisions associated with the resources used to transmit the received transmission; or
identifying a failure to recover the received transmission.

10. The method of claim 1, wherein transmitting the paging message is a part of a random access procedure for the plurality of A-IoT devices, and causing the operation to be performed comprises:
determining, based on the received transmission, that the random access procedure was completed successfully for the plurality of A-IoT devices; and
transmitting, to the wireless network, an indication to de-activate the resource allocation.

11. A wireless transmit/receive unit (WTRU) comprising:
a processor; and
a transceiver coupled to the processor, wherein the WTRU is configured to:
receive, from a wireless network, configuration information indicating a resource allocation for a plurality of ambient internet of things (A-IoT) devices;
determine resource parameters based on the resource allocation, the resource parameters comprising at least one of a time domain resource or a frequency domain resource;
transmit, to the plurality of A-IoT devices, a paging message indicating the resource parameters;
receive a transmission from an A-IoT device of the plurality of A-IoT devices, wherein the transmission from the A-IoT device uses resources identified by the resource parameters; and
cause an operation to be performed based on the received transmission.

12. The WTRU of claim 11, wherein:
the resource parameters comprise the time domain resource; and
the paging message indicates a time offset corresponding to the time domain resource.

13. The WTRU of claim 12, wherein the time offset based on at least one of:
a minimum processing time associated with the plurality of A-IoT devices; or
a maximum time offset associated with the plurality of A-IoT devices.

14. The WTRU of claim 11, wherein:
the resource parameters comprise a first time domain resource and a second time domain resource; and
the paging message indicates a first time offset corresponding to the first time domain resource and a second time offset corresponding to the second time domain resource.

15. The WTRU of claim 14, wherein:
the first time offset is based on at least one of:
a minimum processing time associated with the plurality of A-IoT devices;
a sampling frequency offset between the WTRU and the plurality of A-IoT devices;
a maximum time offset associated with the plurality of A-IoT devices;
a maximum propagation latency associated with the plurality of A-IoT devices; or
a transmission duration associated with the plurality of A-IoT devices; and
the second time offset is based on at least one of:
a maximum monitoring window associated with the plurality of A-IoT devices;
a receive/transmit switching time associated with the WTRU;
the maximum propagation latency associated with the plurality of A-IoT devices;
the sampling frequency offset between the WTRU and the plurality of A-IoT devices; or
the transmission duration associated with the plurality of A-IoT devices.

16. The WTRU of claim 11, wherein the paging message indicates a range of time offset values corresponding to the time domain resource.

17. The WTRU of claim 11, wherein the WTRU is configured to transmit the paging message as a part of a random access procedure for the plurality of A-IoT devices and cause the operation to be performed by:
determining, based on the received transmission, that the resource allocation is not sufficient to complete the random access procedure for the plurality of A-IoT devices;
transmitting, to the wireless network, a request to update the resource allocation;
receiving, from the wireless network, updated configuration information indicating an updated resource allocation for the plurality of A-IoT devices;
determining updated resource parameters based on the updated resource allocation; and
transmitting, to the plurality of A-IoT devices, a re-access paging message indicating the updated resource parameters.

18. The WTRU of claim 11, wherein the WTRU is configured to cause the operation to be performed by:
determining, based on the received transmission, to adjust the resource parameters;
adjusting, based on the resource allocation, the resource parameters; and
transmitting, to the plurality of A-IoT devices, an indication of the adjusted resource parameters.

19. The WTRU of claim 18, wherein the WTRU is configured to determine to adjust the resource parameters based on at least one of:
identifying one or more collisions associated with the resources used to transmit the received transmission; or
identifying a failure to recover the received transmission.

20. The WTRU of claim 11, wherein the WTRU is configured to transmit the paging message as a part of a random access procedure for the plurality of A-IoT devices and cause the operation to be performed by:
determining, based on the received transmission, that the random access procedure was completed successfully for the plurality of A-IoT devices; and
transmitting, to the wireless network, an indication to de-activate the resource allocation.
